(19) United States
(12) Patent Application Publication
(10) Pub. No.: US 2006/0294476 A1
(43) Pub. Date: Dec. 28, 2006

(54) Browsing and previewing a list of items

(75) Inventor: Jamie P. Buckley, Redmond, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/165,078

(22) Filed: Jun. 23, 2005

(51) Int. Cl. G06F 3/00

(52) U.S. Cl. 715/781

(57) ABSTRACT

Integrating the browsing and previewing of a list of items. A list of items is provided for display in a first display area. A list of content abstracts corresponding to the list of items is displayed in the second display area. As the user selects one of the items displayed in the first display area, the content abstract corresponding to the selected item is visually distinguished from the other content abstracts in the second display area.

### BACKGROUND

Known systems enable a user to browse a list of items via a computing device and preview content associated with a particular item in the list. For example, a user interface in these systems may display the list of items in a first display area and display a preview of the associated content in a second display area. Such systems, however, do not correlate the list of items in the first display area with the content preview in the second display area. Further, some systems only provide a preview of a subset of the items.

In FIG. 1, a typical user interface has a list portion and a preview portion for browsing and previewing search results. In FIG. 1, when a user submits a query, the user interface displays two panes, pages, frames, or other display areas. One pane displays titles for the search results for the submitted query (e.g., on the left side of the user interface) and the other pane displays a preview of the search results (e.g., on the right side of the user interface). The preview for a particular search result in this example includes a title, a truncated description, and/or a thumbnail associated with the particular search result. In other typical systems, there is only one results page and previews are shown by “hovering” a selection device (e.g., mouse) over each result.

In existing systems, it is difficult to correlate the search results in one display area with the previews in another display area. Further, the previews are displayed horizontally, which may be counter-intuitive to many users, and only the top results (e.g., six or so) have previews. After selecting one of the search results, full content for that search result overwrites the display area with the previews (e.g., in the right pane), while the search result titles are maintained (e.g., in the left pane). If the user wishes to select a different search result at this point in a typical system, the user can only select a different search result based on the title associated with the search result (e.g., displayed in the left pane). Often, the title alone is insufficient in aiding the user in selecting another search result. In other systems, if the user hovers the mouse over a particular search result (e.g., in the left pane) a concise textual description of the particular search result is shown (e.g., in a popup window). But the concise textual description may also be insufficient to aid the user in choosing a search result.

### SUMMARY

Embodiments of the invention integrate browsing and previewing a list of items. In an embodiment, the invention permits display of a list of items to a user along with a preview of each of the displayed items. When the user selects one of the items from the list of items shown in a display area, the preview corresponding to the selected item may be visually identified to the user in another display area.

Other features will be in part apparent and in part pointed out hereinafter. This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary embodiment of a user interface having a list portion and a preview portion for browsing and previewing search results.

FIG. 2 is an exemplary block diagram illustrating a search infrastructure.

FIG. 3 is an exemplary flow chart illustrating operation of the browsing and previewing aspects of an embodiment of the invention.

FIG. 4 is an exemplary block diagram illustrating a user interface having a list: portion and a preview portion.

FIG. 5 is an exemplary embodiment of a user interface illustrating integration between the list portion and the preview portion of the user interface in FIG. 1.

FIG. 6 is a block diagram illustrating one example of a suitable computing system environment in which aspects of the invention may be implemented.

Corresponding reference characters indicate corresponding parts throughout the drawings.

### DETAILED DESCRIPTION

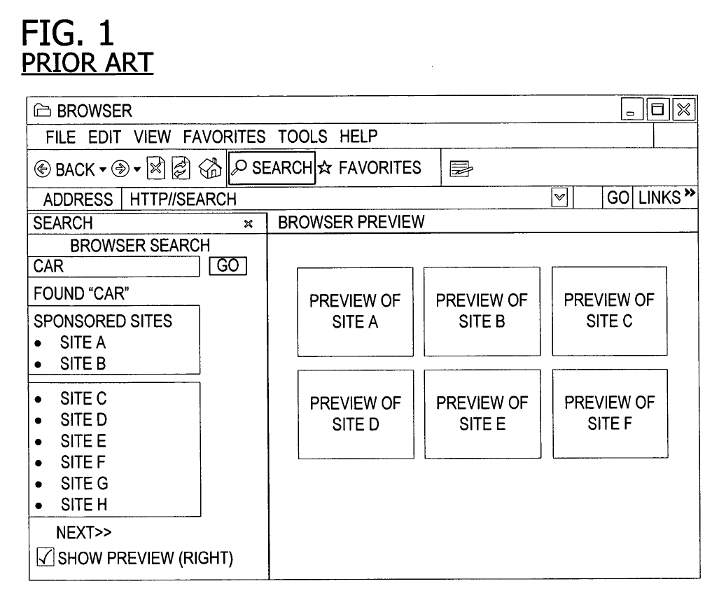

Embodiments of the invention integrate the browsing and previewing of a list of items. While embodiments of the invention may be described herein with reference to specific types of browsable items, embodiments of the invention are operable with browsing and previewing any data stored on any computer-readable medium. In one aspect, the invention is operable with a typical user interface for searching content (e.g., web pages, music, and video) such as shown in FIG. 1. As described above with respect to FIG. 1, a typical user interface has a list portion and a preview portion for browsing and previewing search results. In existing systems, however, it is difficult to correlate the search results in one display area with the previews in another display area.

Embodiments of the invention improve the user experience when browsing any list of items in part by providing the user with sufficient information to effectively browse and preview the list of items.

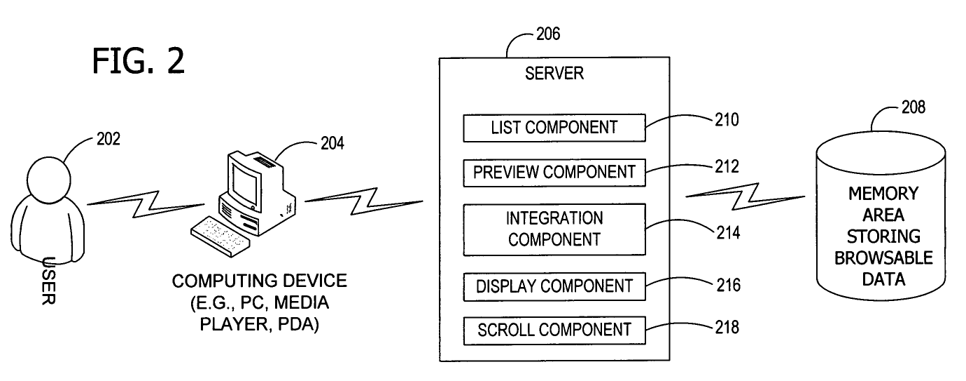

Referring next to FIG. 2, an exemplary block diagram illustrates a networked embodiment of the invention. In this embodiment, a user 202 of a computing device 204 browses data stored in a memory area 208 accessible to a server 206. In an alternative embodiment, the user 202 browses data stored in a memory area 208 that is directly accessible by the computing device 204. In the example of FIG. 2, one or more computer-readable media have computer-executable components for browsing and previewing a plurality of items. The components include a list component 210, a preview component 212, an integration component 214, an integration component 214, a display component 216, and a scroll component 218. The list component 210 generates a plurality of items responsive to a request from a user 202. The list component 210 generates a plurality of identifiers for search results, audio files, video files, image files, recipes, technical articles, news stories, and the like. The preview component 212 generates a plurality of previews each associated with one of the plurality of items generated by the list component 210. In one example, the plurality of identifiers generated by the list component 210 includes a list of audio files (e.g., a music collection). In this case, the plurality of previews generated by the preview component 212 includes audio clips (e.g., ten seconds). In another example, the plurality of identifiers generated by the list component 210 includes a list of movies and the plurality of previews generated by the preview component 212 includes video clips (e.g., trailers). In yet another example, the plurality of identifiers generated by the list component 210 includes a list of news stories and each of the plurality of previews generated by the preview component 212 includes a concise summary or abstract of the news story along with a photograph related to the news story.

The integration component 214 receives a selection of one of the generated plurality of items from the user 202 and identifies to the user 202 one of the plurality of previews corresponding to the received selection. The display component 216 provides, to the user 202 for display, the plurality of items generated by the list component 210, the plurality of previews generated by the preview component 212, and the one of the plurality of previews identified by the integration component 214. The scroll component 218 scrolls the previews to present the identified one of the plurality of previews to the user 202. In one embodiment, a media player embodies the components illustrated in FIG. 2. But the components may be, operable with any hardware and/or software such as any application program executing on any operating system in any device including, but not limited to, a browser executing on a wireless device (e.g., a cellular telephone, a personal digital assistant, and a personal computer).

In general, the infrastructure illustrated in FIG. 2 may be used to integrate the browsing and previewing of any list of items including, but not limited to, Internet searches, intranet searches, searches of technical articles, music, video, files, photos, business listings (e.g., yellow pages), advertisements, residential listings (e.g., white pages), etc. For the yellow pages and white pages exemplary embodiment, the preview may include a map of the residence.

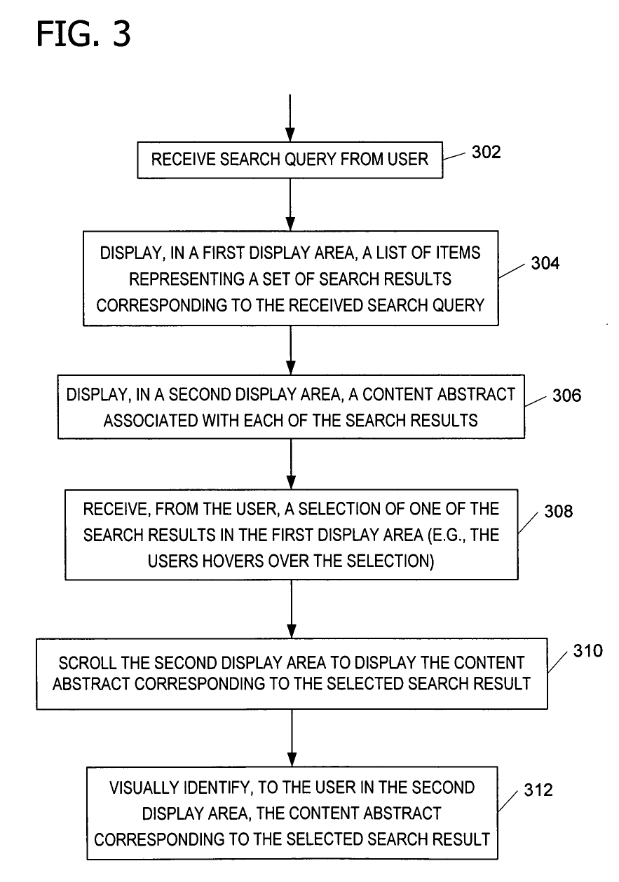

Referring next to FIG. 3, an exemplary flow chart illustrates operation of the browsing and previewing aspects of an embodiment of the invention. In a computing system having a display and a user interface selection device, a computerized method receives a search query from a user at 302. Those skilled in the art are familiar with the use of search engines for generating search results in response to search queries. The method displays, to the user in a first display area, a list of items representing a set of search results at 304 responsive to the user's query. The method displays, to the user in a second display area, a content abstract associated with each of the items in the displayed list at 306. The content abstract may include a preview of the content associated with each item including, but not limited to, an image of the page, a title, a URL, a truncated textual description of the page, a download time for the page, a category of the page, and a thumbnail image.

The method further receives, from the user, a selection of one of the items in the displayed list at 308. For example, the user may hover over one of the items in the displayed list (e.g., via a mouse). In an embodiment in which the content abstracts exceed the size of the second display area, the method scrolls the displayed content abstracts in the second display area at 310 to present the content abstract corresponding to the received selection to the user. The method visually identifies, to the user in the second display area, the displayed content abstract corresponding to the received selection at 312. The visual identification may take the form of any visual identification or marker for the content abstract corresponding to the received selection including, but not limited to, a box, a pointer, a font change, a font size change, a color change, a formatting change (e.g., bold, italics, or underline), or highlighting.

When the user selects one of the items in the displayed list (e.g., by clicking on the search result), the method displays, in the second display, area, content associated with the selected item. In this example, the previews in the second display area are overwritten by the content associated with the selected item while the list of items in the first display area is maintained for future use by the user.

In one embodiment, one or more computer-readable media have computer-executable instructions for performing the method illustrated in FIG. 3.

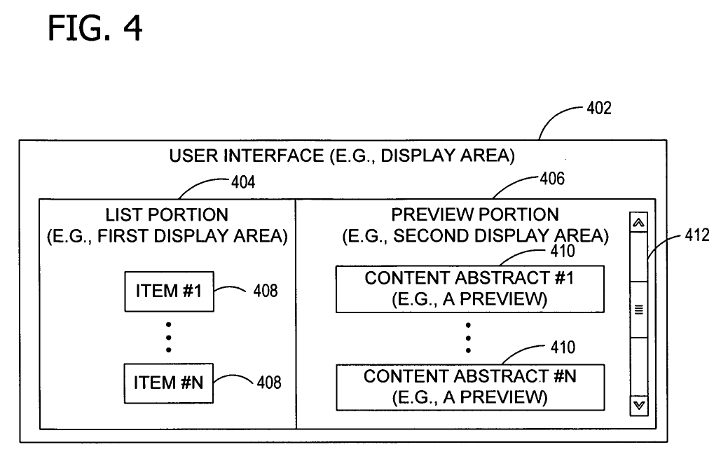

Referring next to FIG. 4, an exemplary block diagram illustrates a user interface 402 having a list portion 404 and a preview portion 406. The two portions 404, 406 of the user interface 402 or other display area for browsing and previewing a list of items 408 may be referred to in numerous ways including, but not limited to, first and second display areas, list and preview portions, and search and preview panes. In general, the user interface 402 may include any display area such as a frame, pane, or window (e.g., in an Internet browser). In the example of FIG. 4, the list portion 404 displays to a user a plurality of items 408 such as item #1 through item #N. For example, an exemplary list portion 404 may include a search pane displaying the search query and titles of the search results. The preview portion 406 displays to the user a plurality of content abstracts 410 (e.g., previews of images, text, audio, and/or video) such as content abstract #1 through content abstract #N. Each of the content abstracts 410 corresponds to one of the items 408 displayed in the list portion 404. For example, the content abstracts 410 may include an abbreviated contextual description of the items 408 corresponding thereto. In one example, an exemplary preview portion 406 may include previews for one or more of the search result titles displayed in the list portion 404. When the user selects a particular item, the content abstract corresponding to the selected item is visually distinguished from the other content abstracts 406. The user interface 402 of FIG. 4 further includes a scroll bar 412 responsive to the user selecting the particular item to automatically scroll to the corresponding content abstract.

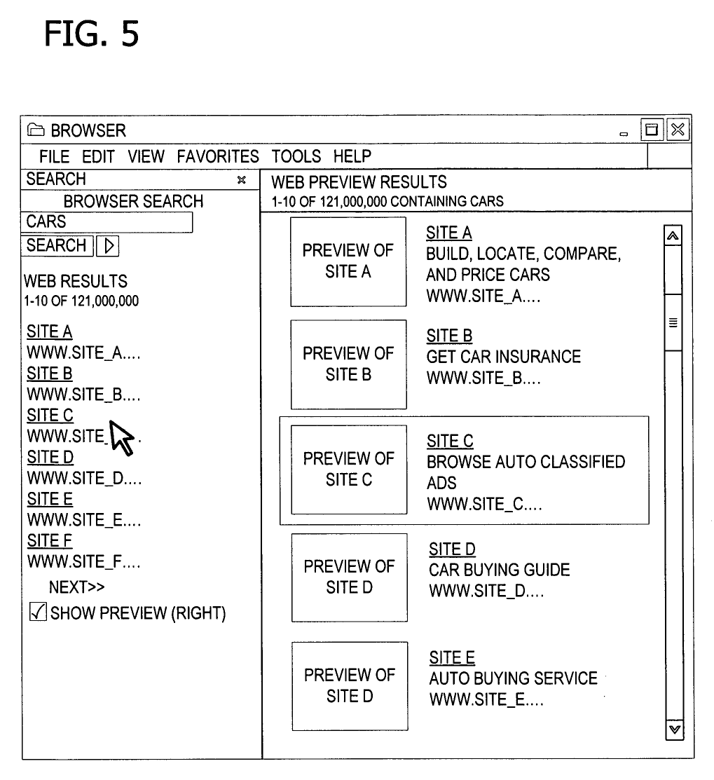

Referring next to FIG. 5, a user interface illustrates integration between the list portion and the preview portion of the user interface in FIG. 1. The exemplary user interface includes a search pane and a search preview pane. The user interface in FIG. 5 correlates results in the search pane to the previews in the search preview pane. The titles of the search results and other information (e.g., the domain of each result) are displayed in the search pane. Previews of the search results are displayed in the search preview pane vertically. The previews in the search preview pane may include, but are not limited to, a thumbnail of the target page (e.g., the home page of the target page), title, contextual description and uniform resource locator (URL) of the target page. The previews may also include additional information such as the topical category of the result, page size, download time of the target page, or the like.

When the user hovers the mouse or other user interface selection device over a title in the search pane window, a box or other visual indicator is shown around the corresponding preview in the search preview pane. The search preview pane automatically scrolls to corresponding preview if the corresponding preview is not visible in the search preview pane. After a search result is selected (e.g., clicked) in the search pane, content for the selected results overwrites the previews in the search preview pane.

If the preview content is overridden by selected content, the search pane may also show extra information about the corresponding result when the user hovers the mouse over results in the search pane (e.g., in a small popup or overlay window with the extra information, without completely overwriting the content displayed). The extra information may include one or more of the following: a result title, a description, a target URL, and a thumbnail of each page. The small popup window may be shown in the main content window, or in the search pane itself

One embodiment of the invention provides an option to “dock results to the search pane” as users are browsing. An additional option may specify that the search results be moved to the search pane when a result is clicked in the preview pane. For example, this additional option may be applicable in a common search scenario where there is just one pane of results without the ability to preview. This option enables the users to have search results always visible on the page. In general, there is a static space for the search pane that does not change as the user browses.

Exemplary Operating Environment

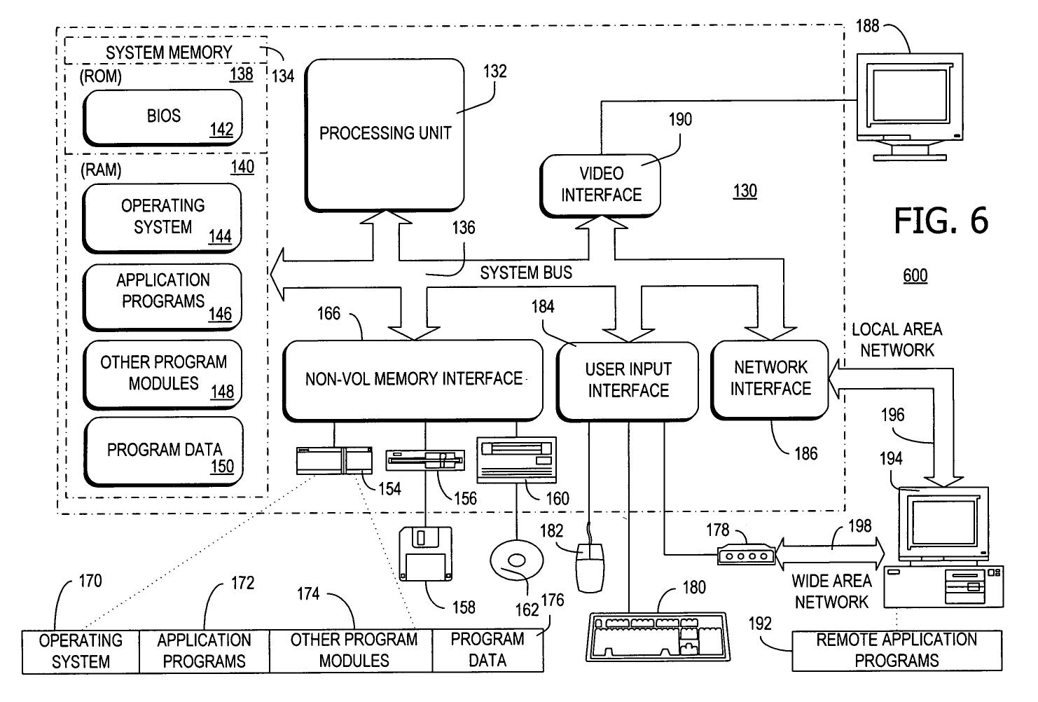

FIG. 6 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available, medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 6 illustrates operating system 144, application programs 146, other program modules 148, and program data 150.

The computer 130 may also include other removable/non-removable, volatile/nonvolatile computer storage media. For example, FIG. 6 illustrates a hard disk drive 154 that reads from or writes to non-removable, nonvolatile magnetic media. FIG. 6 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile, computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 6, provide storage of computer readable instructions, data structures, program modules and other data for the computer 130. In FIG. 6, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 6 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used, in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 6 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Aspects of the invention described herein include these and other various types of computer-readable storage media when such media contain instructions or programs for implementing the steps described below in conjunction with a microprocessor or other data processor. Aspects of the invention also include the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, embodiments of the invention are operational with numerous other general purpose or special purpose computing system environments or configurations. The computing system environment is not intended to suggest any limitation as to the scope of use or functionality of aspects of the invention. Moreover, the computing system environment should not be interpreted as having any dependency or requirement relating to any one or combination of components illustrated in the exemplary operating environment. Examples of well known computing systems, environments, and/or configurations that may be suitable for use with embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Aspects of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Embodiments of the invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further the interfaces may include additional or less functionality than illustrated or described herein.

In operation, computer 130 executes computer-executable instructions such as those illustrated in the figures to implement aspects of the invention.

The order of execution or performance of the operations illustrated and described herein is not essential, unless otherwise specified. That is, the operations may be performed in any order, unless otherwise specified, and the operations may include more or less elements than those disclosed herein. For example, it is contemplated that executing or performing a particular operation or element before, contemporaneously with, or after another operation or element is within the scope of an embodiment of the invention.

When introducing elements of embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Although the subject matter has been described in language specific to structural features and/or methodological acts, it is to be understood that the subject matter defined in the appended claims is not necessarily limited to the specific features or acts described herein. Rather, the specific features and acts described above are disclosed as example forms of implementing the claims.

What is claimed is:

1. One or more computer-readable media having computer-executable components for browsing and previewing a plurality of items, said components comprising:
a list component for generating, responsive to a request from a user, a plurality of items for display in a first display area;
a preview component for generating a plurality of previews for display in a second display area, each of the plurality of previews being associated with one of the plurality of items generated by the list component; and
an integration component for:
receiving a selection from the user of one of the generated plurality of items in the first display area; and
identifying, in the second display area, one of the plurality of previews corresponding to the received selection.

2. The computer-readable media of claim 1, further comprising a display component for providing, to the user for display, the plurality of items generated by the list component, the plurality of previews generated by the preview component, and the one of the plurality of previews identified by the integration component.

3. The computer-readable media of claim 1, further comprising a scroll component for presenting the identified one of the plurality of previews to the user.

4. The computer-readable media of claim 1, wherein the list component generates a plurality of items including identifiers for one or more of the following: search results, audio files, video files, image files, recipes, technical articles, and news stories.

5. The computer-readable media of claim 1, further comprising a media player embodying the list component, preview component, and integration component.

6. The computer-readable media of claim 1, wherein the integration component maps each of the generated plurality of items to a corresponding preview in the plurality of previews.

7. A user interface for browsing and previewing a list of items, said user interface comprising:
a list portion for displaying to a user a plurality of items; and
a preview portion for displaying to the user a plurality of content abstracts each corresponding to one of the items displayed in the list portion, said displayed plurality of content abstracts including a particular content abstract associated with a particular item displayed in the list portion, said particular content abstract being visually distinguished from the other content abstracts when the user selects the particular item.

8. The user interface of claim 7, wherein the particular content abstract is visually distinguished from other content abstracts by one or more of the following: a box encompassing the particular content abstract, color, size, and formatting.

9. The user interface of claim 7, wherein each of the content abstracts comprises one or more of the following: an image, text, audio, and video; and wherein the list portion displays to the user a list of one or more of the following: search results, audio files, video files, image files, recipes, technical articles, and news stories.

10. The user interface of claim 7, further comprising a scroll bar, responsive to the user selecting the particular item, to automatically scroll to the particular content abstract associated with the particular item selected by the user.

11. The user interface of claim 7, wherein the particular content abstract includes one or more of the following associated with the particular item: a thumbnail image and an abbreviated contextual description of the particular item.

12. In a computing system having a display and a user interface selection device, a computerized method of browsing search results, said method comprising:
displaying, to a user in a first display area, a list of items representing a set of search results;
displaying, to the user in a second display area, a plurality of content abstracts, said content abstracts being associated with at least a portion of the items in the displayed list;
receiving, from the user, a selection of one of the items in the displayed list; and
visually identifying, to the user in the second display area, one of the content abstracts corresponding to the received selection.

13. The method of claim 12, wherein visually identifying one of the content abstracts comprises scrolling the content abstracts displayed in the second display area to present the visually identified content abstract to the user in response to the received selection.

14. The method of claim 12, wherein displaying the content abstracts comprises displaying thumbnail images associated with the items.

15. The method of claim 12, further comprising receiving a search query from the user, wherein the search results are generated by a search engine in response to the search query.

16. The method of claim 12, wherein each of the items in the displayed list has content associated therewith, and further comprising:
receiving another selection of one of the items in the displayed list; and
displaying, to the user in the second display area, the content associated with the other selected item.

17. The method of claim 16, wherein the other selection comprises the user clicking on the one of the items in the displayed list.

18. The method of claim 16, wherein displaying the content associated with the other selected item comprises displaying, to the user in the second display area, the content associated with the other selected item while displaying the list of items in the first display area.

19. The method of claim 12, wherein the selection comprises the user hovering a user input device cursor over the one of the items in the displayed list.

20. The method of claim 12, wherein one or more computer-readable media have computer-executable instructions for performing the method of claim 12.
